(19) United States
(12) Patent Application Publication
(10) Pub. No.: US 2010/0260899 A1
(43) Pub. Date: Oct. 14, 2010

(54) AERATED CENTREFILLED CONFECTIONERY COMPOSITION

(76) Inventors: Nathalie Montaigne, Divonne Les Bains (FR); Patrice Demeulemeester, Linselles (FR); Simone Gunther, Reading (GB)

Correspondence Address: CANTOR COLBURN, LLP, 20 Church Street, 22nd Floor, Hartford, CT, 06103, US

(21) Appl. No.: 12/679,540

(22) PCT Filed: Sep. 25, 2008
(86) PCT No.: PCT/GB08/03247

§ 371 Date: Jun. 22, 2010

(30) Foreign Application Priority Data
Sep. 25, 2007 (GB) 0718661.2

(51) Int. Cl. A23G 3/52; A23G 3/00; A23G 3/54; A23P 1/10

(52) U.S. Cl. 426/103; 426/474

(57) ABSTRACT

A centrefilled confectionery composition comprises a centrefill component enclosed in a confectionery shell component. At least one of the components is aerated, and the densities of the centrefill and the shell are substantially equal. The confectionery shell component may comprise jelly candy or hard-boiled candy. A method of making a centrefilled confectionery composition, comprising a centrefill enclosed in a confectionery shell, comprises preparation of first and second syrups for forming the confectionery shell and centrefill respectively. The densities of the first and second syrups are compared, and the denser of the two syrups is aerated to reduce the density to a level comparable to the density of the other syrup. The first and second syrups are then co-deposited into a mould so that the first syrup forms a confectionery shell enclosing a centrefill formed by the second syrup.

This invention relates to the formulation of confectionery compositions. More specifically, it relates to a method of making centrefilled confectionery compositions.

It is known for certain confectionery compositions, such as hard-boiled candies, jelly candies and chewy candy, to contain a ‘centrefill’ (which may be liquid, e.g. a syrup, but is usually a gel or paste) encased within a shell. This centrefill provides a pleasing sensation when it is released into a consumer's mouth, either by biting into the confectionery composition, or by the consumer allowing the shell to dissolve. Additionally, the centrefill may have a flavour (or other discernable property, such as acidity or cooling effect) that is noticeably different to that of the shell, further adding to the pleasurable experience on consumption as a result in the contrast of tastes and mouthfeel. Such centrefilled confectionery compositions are commonly produced by co-depositing solutions (which may be heated above room temperature) of the shell material and the centrefill material into a mould (such as an impression formed in a starch tray). Following deposition, the shell material solidifies to form a shell fully enclosing the centrefill.

The potential benefit of the centrefill is limited by the need to ensure product integrity during packaging, storage and transport of the confectionery, so that the centrefill remains enclosed within the shell until the composition is eaten. To date, efforts in this regard have concentrated on ensuring that the centrefill is deposited in the centre of the mould cavity, as viewed from the point of deposition, and controlling the quantity of centrefill relative to that of the shell material, so that the shell exceeds the required minimum thickness (and hence the required strength) at all points around the centrefill.

However, it is difficult to control the vertical (i.e. along the axis of deposition) displacement of the centrefill relative to the confectionery composition, which may lead to products in which the regions of the confectionery shell at the upper and lower regions of the mould cavity are too thick or too thin.

The present invention has been conceived with the above problems in mind.

According to a first aspect of the present invention there is provided a centrefilled confectionery composition comprising a centrefill enclosed in a confectionery shell, characterised in that at least one of the centrefill and the confectionery shell is aerated and the densities of the centrefill and confectionery shell are substantially equal.

As used herein, the term ‘aerated’ is intended to mean that a confectionery component comprises entrapped air or other gas. In general, aerated confectionery components will have a density less than 1.25 gcm⁻³. In one embodiment, the density of the aerated component may be less than or equal to 1.1 gcm⁻³. In a further embodiment, the density of the aerated component may be between 0.6 and 1.1 gcm⁻³. Components with such densities may be suitable for use in a depositor. In an alternative embodiment, the density of the aerated component may be between 0.25 and 0.6 gcm⁻³. Components with such densities may be suitable for use in an extruder.

In one embodiment, the aerated confectionery component(s) (i.e. shell and/or centrefill) comprises at least 5% v/v entrapped gas. In a further embodiment, the aerated confectionery component(s) comprises at least 10% v/v entrapped gas. In a still further embodiment, the aerated confectionery component(s) comprises at least 15% entrapped gas.

It will be understood that transfer of moisture between the centrefill and the confectionery shell is to be avoided. In one embodiment, therefore, the water activity (Aw) of the centrefill and the confectionery shell will be substantially equal.

According to a second aspect of the present invention there is provided a method for manufacturing a centrefilled confectionery composition comprising a centrefill enclosed in a confectionery shell, the method comprising:
(a) preparing a first syrup for forming the confectionery shell;
(b) preparing a second syrup for forming the centrefill;
(c) comparing the densities of the first and second syrups;
(d) aerating the denser of the first and second syrups to reduce the density to a level comparable with that of the less dense of the first and second syrups; and
(e) co-depositing the first and second syrups into a mould cavity such that, on cooling, the first syrup forms a confectionery shell enclosing the centrefill formed by the second syrup.

As used herein, the terms ‘substantially equal’ and ‘comparable with’ in relation to the densities of the syrups and confectionery components, are intended to mean that the density of the denser of the components under comparison is within 2% of the density of the less dense component. In a further embodiment, the density of the denser component is within 1% of that of the less dense component; in a still further embodiment, within 0.75%; and in a still further embodiment, within 0.5%.

It is believed that differences in density between the centrefill syrup and the shell candy syrup can result in movement of the centrefill relative to the shell after deposition but before the shell syrup has fully set. For example, if the centrefill syrup has a density which is appreciably lower than that of the shell syrup, the centrefill will rise towards the upper region of the mould cavity. In this case, even though the centrefill has been correctly deposited, one wall of the candy shell enclosing the centrefill (i.e. that formed at upper region of the mould cavity) will be thinner than required and may be liable to rupture during manufacture and/or storage, lead to wastage and to unsatisfactory product.

The inventors have surprisingly found that it is possible to incorporate air into the syrups, and thereby adjust the densities thereof, without loss of the required properties of the syrup (e.g. gel-forming ability, texture, etc.). In order to allow for deposition, the specific gravity of a syrup must be between 0.6 and 1.25; thus, the aeration of a syrup under the present invention should not take the specific gravity thereof outside this range.

In one embodiment, the first syrup is initially denser than the second syrup.

In one embodiment, the second syrup may contain dietary fibre. Alternatively or in addition, the first syrup may be substantially free from fibre.

In this context, ‘substantially free from’ means that any fibre present in a jelly candy or chewy candy shell layer is at a sufficiently low level that it will not disrupt the texture of the gelatin. The amount of fibre necessary to disrupt the gelatin structure will depend on the exact fibre used, but may be readily determined by observing the strength of the gel at increasing levels of fibre, and noting the point at which the gel softens. For example, it is possible to incorporate no more than 0.2% by weight pectin in a jelly candy layer to promote gelling during deposition without disrupting the gelatin texture. Similarly it is possible to incorporate up to 1-2% starch in a jelly candy layer. Where both pectin and starch are present, however, the amount of each would need to be reduced.

In one embodiment, therefore, ‘substantially free from’ means that the first syrup contains no more than 2% by weight of fibre. Alternatively, ‘substantially free from’ may mean that the first syrup contains no more than 1% by weight, or no more than 0.5% by weight, or no more than 0.2% by weight of fibre.

In one embodiment, the confectionery shell may be jelly candy or hard-boiled candy.

Jelly candies, also known as gummy candies, are a popular confectionery snack, since they combine a desirable chewing sensation with a sweet flavour. Jelly candies have traditionally been manufactured using a sugar together with a gelling agent such as gelatin.

As used herein, ‘hard boiled candy’ refers to an amorphous glassy candy produced by heating a syrup of sugar (or suitable sugar-free bulk sweetener) to drive off most of the water, as is well known in the art.

The second syrup may be such that the resulting centrefill is a liquid (such as a viscous syrup) or a low- or high-viscosity gel.

The second syrup may be, according to one embodiment, such that the resulting centrefill is a semi-liquid or low viscosity gel. According to an alternative embodiment, the second syrup may be such that the centrefill is a rigid or high-viscosity gel. In one embodiment, the second syrup may be such that the viscosity of the resulting centrefill is greater than 900 mPas, as measured using a Brookfield viscometer.

It will be understood that transfer of moisture between the centrefill and the confectionery shell is to be avoided. In one embodiment, therefore, the first and second syrups may have compositions such that the water activities (Aw) of the confectionery shell and the centrefill are substantially equal.

In one embodiment, the ratio of the amounts by weight of first and second syrups co-deposited should be no more than 3:1, so that the centrefill forms at least 25% by weight of the final centrefilled confectionery composition. Alternatively, the ratio of first and second syrups may be such that the centrefill forms at least 30%, at least 40% or at least 50% by weight of the centrefilled confectionery composition.

In one embodiment, the second syrup comprises between 1 and 15% by weight soluble dietary fibre. In addition, the second syrup may comprise up to 30% insoluble dietary fibre, or may be free from insoluble dietary fibre. In a further embodiment, at least one of the first and second syrups comprises one or more sugar alcohols, and the second syrup comprises sufficient soluble dietary fibre to reduce the laxative effect of the sugar alcohol in the resulting centrefilled confectionery composition.

In one embodiment, the dietary fibre in the centrefill comprises one or more soluble hydrocolloids. In a further embodiment, at least one of the one or more soluble hydrocolloids is selected from xanthan gum, pectin, locust bean gum, psyllium and sodium alginate. In yet another embodiment, the dietary fibre is selected from a blend of xanthan gum and locust bean gum, sodium alginate, pectin, and a blend of pectin and xanthan gum. In a still further embodiment, the dietary fibre is selected from a blend of xanthan gum and locust bean gum, and sodium alginate. Where the dietary fibre comprises a blend of xanthan gum and locust bean gum, this blend may contain a ratio of from 4:96 to 12.5:87.5 xanthan gum:locust bean gum. Where the dietary fibre comprises a blend of alginates, this blend may contain from 0:100 to 50:50 low viscosity : high viscosity alginates.

In one embodiment, the at least one of the first and second syrups is substantially sugar-free. In a further embodiment, both of the first and second syrups are substantially sugar-free.

In one embodiment, at least one of the first and second syrups comprises one or more sugar alcohols. Alternatively, both the first and second syrups may comprise one or more sugar alcohols. The one or more sugar alcohols may be selected from the group consisting of mannitol, sorbitol, hydrogenated isomaltulose, hydrogenated glucose, erythritol, maltitol, lactitol and xylitol.

Centrefilled confectionery compositions are commonly made through co-deposition of appropriate solutions into moulds. Such moulds may be of any type commonly known in the art; for example they may be flexible plastic trays which facilitate the release of the finished confectionery products, or they may be formed as impressions in a starch tray. Co-deposition may be achieved through any suitable method known in the art, such as (but not exclusively) the use of a commercial apparatus (e.g those manufactured by Makat Candy Technology GmbH, Dierdorf, Germany).

Where the centrefill is liquid or semi-liquid in nature, it is important that the centrefill forms in the centre of the confectionery composition. Co-deposition should therefore be controlled so that, at the point of deposition, the centrefill syrup is located at the centre of the mould cavity and is completely surrounded by shell syrup. If the centrefill is located towards one edge of the confectionery composition, the relatively thin shell wall at that point may be a point of weakness. Rupture of the outer shell layer can lead to leaking of the centrefill.

The appearance of the resulting shell confectionery and the centrefill may be controlled through use of food colourings in the first and second syrups, as is known in the art. In particular, it may be preferable for the outer shell layer to be (at least partially) translucent, and the centrefill coloured, so that the centrefill may be seen through the shell layer. It may be particularly desirable for the outer layer to be transparent, colourless, or both, to improve the visibility of the coloured centrefill.

According to a third aspect of the invention, there is provided a centrefilled confectionery composition obtainable according to the method of the second aspect of the present invention.

In the following compositions, all references to amounts of ingredients refer to the percentage by weight of the relevant candy composition.

A typical composition of a jelly (or gummy) candy is:
Sucrose or other bulk sweetener in amorphous form—30-60%
Glucose syrup or other bilk sweetener in amorphous form—30-60%
Gelling agent—up to 10%
Flavours, colours, acid, intense sweeteners—as required

The moisture content of a jelly candy is typically 10-22%.

A typical composition of a hard boiled candy is:
Sucrose or other bulk sweetener in crystalline form—30-60%
Glucose syrup or other bulk sweetener in amorphous form—30-60%
Fat—0-10%
Emulsifying compounds—0-2%
Flavours, colours, acid, intense sweeteners—as required

The moisture content of a hard boiled candy is typically 1-6%.

In all cases, the moisture loss on deposition is minimal. Thus, these compositions will also apply to the syrups from which the shells are formed.

Suitable fats include hydrogenated vegetable oil, hydrogenated palm kernel oil, coconut fat, palm oil, milk fat, cotton seed oil, and cocoa butter. Suitable emulsifiers include sucrose esters, lecithin, polyglyceryl-10 dipalmitate (POLYALDO), polysorbates (TWEENs) and sorbitan fatty acid esters (SPANS), glycerol monostearate, mono- and diglycerides of fatty acids, and polyglycerol polyricinoleate (PGPR).

As used herein, the term ‘bulk sweetener’ has the ordinary meaning in the art, and refers to an ingredient which typically adds both bulk and sweetness to a confectionery composition. In general, bulk sweeteners may be sugar or sugarless. The bulk sweeteners used in the outer shell layer and in the centrefill may be the same or different, and each layer may use one bulk sweetener only, or more than one bulk sweetener. Suitable sugarless bulk sweeteners may include sugar alcohols (hydrogenated saccharides), including erythritol, hydrogenated isomaltuose, lactitol, maltitol, mannitol, sorbitol, xylitol, and hydrogenated starch hydrolysates. In addition, the centrefilled confectionery composition may contain bulk sweeteners such as polydextrose, dextrin, starches resistant to degradation in the human gut (e.g those available under the trade names FIBERSOL-2 from Matsutani, HI-MAIZE from National Stach, ACTISTAR from Cargill), frcto-oligosaccharides, inulin and galacto-oligosaccharides. Sugar sweeneters may include glucose, fructose, sucrose, corn syrup, or maltodextrin. Whilst the use of exclusively sugarless sweeteners is preferred, sugar and sugarless sweeteners may be used in combination, or sugar sweeteners may be used exclusively.

Dietary fibre refers to the indigestible portion of plant food. Although not a direct source of nutrition (being indigestible), the consumption of dietary fibre is believed to be beneficial to health by aiding digestion, and to the suppression of appetite. Dietary fibre may be insoluble or soluble in water, with both soluble and insoluble fibres mixing readily with water.

Soluble dietary fibres including gums, pectins, psyllium and beta-glucans have similar biological effects. Due to their viscosity they delay gastric emptying (Low, 1990; Roberfroid, 1993) and cause an additional expansion of the unstirred layer in the small intestine which further delays digestion and absorption (Blackburn et al, 1992). Thus, in many studies they have been reported to lower postprandial blood glucose in both normal and diabetic subjects (Flammang et al, 2006; Goulder et al 1978; Woolever and Jenkins, 1993). In addition, a sense of satiety may result from the prolonged presence of nutrients in the small intestine (Sepple and Read, 1989; Chow et al, 2006). Through the enhancement of satiety and fecal energy losses, some soluble viscous fibres such as glucomannan, may aid in weight management (Keithley and Swanson, 2005, Birketvedt, et al, 2005). Soluble dietary fibres also have effects on cardiovascular risk factors including a lowering of total and LDL cholesterol, triglycerides and blood pressure (Vuksan et al, 1999: Aro et al, 1984; Bosello et al, 1984; Krotkiewski, 1987; Blake et al, 1997).

Particularly suitable soluble fibres for use in the present invention include hydrocolloids such as alginates, xanthan gum, locust bean gum, tara gum, low acyl gellan, agragos, etc. Suitable insoluble fibres include salts of carboxymethylcellulose, such as sodium carboxymethylcellulose.

Where the second syrup comprises pectin, it should be kept at temperatures of at least 60° C. to prevent gelation of the syrup before deposition of the confectionery composition.

The inclusion of fibre in the second syrup necessitates a relatively high moisture content in the resultant centrefill to ensure hydration of the fibre. At the same time, the water activity (AW) of the centrefill should be maintained below 0.6 in order to prevent the growth of microbes. This can be done by increasing the content of low molecular weight carbohydrates, such as sorbitol and glycerol, as will be readily understood by the skilled man.

The invention will now be further described by way of example.

A first syrup for forming a jelly candy shell layer is formed as follows:

A gelatin solution is prepared according to Table 1. The water is heated to 60 ° C., the gelatin is stirred in, and the mixture is covered and kept warm until the gelatin has dissolved (approximately 30 minutes). The resulting solution is stirred well before being used.

TABLE 1
Gelatin solution

| | |
|---|---|
| Gelatin 250 bloom (96% dry solids) | 400 g |
| Water | 600 g |
| Total | 1000 g |

A sugar solution is prepared according to Table 2.

TABLE 2
Sugar solution

| | | |
|---|---|---|
| Granulated sugar | 275 | g |
| Glucose 63DE | 625 | g |
| Water | 80 | g |
| Modified food starch | 20 | g |
| Total | 1000 | g |

The modified food starch used is that sold as ULTRA-TEX 2 by the National Starch Company.

The starch is first dispersed in the granulated sugar. All of the ingredients are then boiled together (at approximately 92° C.) until a concentration of 77.8 wt % is achieved, as measured by weight loss during evaporation. The sugar solution is then mixed with gelatin syrup and citric acid as shown in Table 3.

TABLE 3
First syrup

| | | |
|---|---|---|
| Sugar syrup | 818.5 | g |
| Gelatin solution | 173.5 | g |
| 50% Citric acid solution | 8.0 | g |
| Total | 1000 | g |

A sugar-free second syrup for forming a centrefill is prepared according to Table 4. The xanthan gum is dispersed in the sorbitol using a blender, and then the mixture is placed in a saucepan. Water and glycerol are added, and the mixture is heated to remove the stated amount of water.

TABLE 4
second syrup

| | | |
|---|---|---|
| Sorbitol P60 | 150 | g |
| Water | 100 | g |
| Glycerol | 12.5 | g |
| Xanthan gum | 12.5 | g |
| Total before evaporation | 275 | g |
| Amount of water to be evaporated | 25 | g |

### COMPARATIVE EXAMPLE

The first and second syrups are co-deposited into starch moulds using a Makat depositor with the following settings:

| | |
|---|---|
| Shell stroke | 22 |
| Shell speed | 100 |
| Shell suck back | 1 |
| Filling stroke | 17 |
| Filling speed | 170 |
| Filling suck back | 1 |
| Start point | 0.5 |

Of the centrefilled jelly candy items produced, the failure rate due to leakage of the centrefill is found to be relatively high

### EXAMPLE

The specific gravities of the above first and second syrups are measured, with that of the first syrup being found to be higher than that of the second. The first syrup is therefore aerated by whipping in a planetary mixer under atmospheric temperature and pressure to obtain a specific gravity within 0.75% of the specific gravity of the second syrup. The first and second syrups are then co-deposited into starch moulds in a manner similar to that used for the Comparative Example.

Of the centrefilled jelly candy items produced the failure rate due to leakage of the centrefill is found to be lower than that for the Comparative Example. Thus, it can be seen that aeration of the shell syrup leads to a significantly increased product integrity.

It will be understood that other aeration techniques may be used in the above Example. For example, the material may be injected together with compressed gas (air, nitrogen, etc) into a mixer having a rotor and a stator with intermeshing pins. Such mixers may be available from Haas-Mondomix B.V., Almere, Netherlands.

1. A centrefilled confectionery composition comprising a centrefill component enclosed in a confectionery shell component, characterised in that at least one of the components is aerated to contain at least 5% v/v entrapped gas and the densities of the centrefill and the confectionery shell are substantially equal.

2. The centrefilled confectionery composition of claim 1, wherein the density of the confectionery shell is within 1% of that of the centrefill.

3. The centrefilled confectionery composition of claim 2, wherein the density of the confectionery shell is within 0.75% of that of the centrefill.

4. The centrefilled confectionery composition of claim 3, wherein the density of the confectionery shell is within 0.5% of that of the centrefill.

5. The centrefilled confectionery composition of claim 1, wherein the density of the aerated component is less than 1.25 gcm⁻³.

6. The centrefilled confectionery composition of claim 5, wherein the density of the aerated component is less than or equal to 1.1 gcm⁻³.

7. The centrefilled confectionery composition of claim 6, wherein the density of the aerated component is between 0.6 and 1.1 gcm⁻³.

8. The centrefilled confectionery composition of claim 6, wherein the density of the aerated component is between 0.25 and 0.6 gcm⁻³.

9. The centrefilled confectionery composition of claim 1, wherein the confectionery shell component comprises jelly candy.

10. The centrefilled confectionery composition of claim 1, wherein the confectionery shell component comprises hard-boiled candy.

11. The centrefilled confectionery composition of claim 1, wherein the centrefill comprises dietary fibre.

12. The centrefilled confectionery composition of claim 1, wherein the confectionery shell is substantially free from dietary fibre.

13. A method of manufacturing a centrefilled confectionery composition comprising a centrefill enclosed in a confectionery shell, the method comprising:
a) preparing a first syrup for forming the confectionery shell;
b) preparing a second syrup for forming the centrefill;
c) comparing the densities of the first and second syrups;
d) aerating the denser of the first and second syrups to contain at least 5% v/v entrapped gas and thereby reduce the density to a level comparable with that of the less dense of the first and second syrups; and
e) co-depositing the first and second syrups into a mould cavity such that the first syrup forms a confectionery shell enclosing a centrefill formed by the second syrup.

14. The method of claim 13, wherein step d) comprises aerating the denser of the first and second syrups to a level within 1% of the density of the less dense component.

15. The method of claim 14, wherein step d) comprises aerating the denser of the first and second syrups to a level within 0.75% of the density of the less dense component.

16. The method of claim 15, wherein step d) comprises aerating the denser of the first and second syrups to a level within 0.5% of the density of the less dense component.

17. The method of claim 13, wherein the density of the less dense component is less than 1.25 gcm⁻³.

18. The method of claim 17, wherein the density of the less dense component is less than or equal to 1.1 gcm⁻³.

19. The method of claim 18, wherein the density of the less dense component is between 0.6 and 1.1 gcm⁻³.

20. The method of claim 13, wherein in step c), the first syrup is found to be denser than the second syrup.

21. The method of claim 13, wherein the second syrup comprises dietary fibre.

22. The method of claim 13, wherein the first syrup is substantially free from dietary fibre.

23. The method of claim 13, wherein the confectionery shell comprises jelly candy.

24. The method of claim 13, wherein the confectionery shell comprises hard-boiled candy.

25. (canceled)
